(19) United States
(12) Patent Application Publication
(10) Pub. No.: US 2003/0151885 A1
(43) Pub. Date: Aug. 14, 2003

(54) Control system for peripheral devices of a high-density server

(76) Inventor: Ben Chang, Taipei (TW)

Correspondence Address: BIRCH STEWART KOLASCH & BIRCH, PO BOX 747, FALLS CHURCH, VA, 22040-0747, US

(21) Appl. No.: 10/073,418

(22) Filed: Feb. 13, 2002

(51) Int. Cl. H02B 1/00

(52) U.S. Cl. 361/600

(57) ABSTRACT

A control system for peripheral devices of a high-density server. A USB interface is used to connect several motherboards of a high-density server with a system connection back panel and a system management unit, and to control several peripheral devices. The control system of the invention includes a plurality of motherboard USB ports, a USB interface switching module, a USB extension device and a switch control unit.

### BACKGROUND OF THE INVENTION

1. Field of Invention

The invention relates to a control system for peripheral devices of a high-density server, which utilize a USB interface to control and connect peripheral devices of the high-density server.

2. Related Art

A server in the network system provides a variety of services for different terminals, such as databases, file storage, printers, email, web pages, and so on. In order to provide the above services for multiple terminals, the server needs to have the ability to process and respond to all requests and information transmitted from the multiple terminals simultaneously. In regards to hardware, multiple I/O ports have to be installed at the server to receive the information transmitted from the multiple terminals. As far as software goes, the server must be capable of managing the information transmitted from the multiple terminals. Since the server has to service multiple terminals, a heavy load must be born by the hardware and there is great difficulty in managing the software if there are too many I/O ports in the server. Due to the demand of servicing all terminals, multi-purpose motherboards designed for different services are used in a high-density server. Therefore, a server only has to manage the motherboards and the system management becomes much easier.

Although the server can service multiple terminals, the most important issue for the designer is whether the server supports a particular peripheral device. For example, does the server support peripheral devices such as keyboards, mice, floppy disk drives, or CD-ROM's? If it does, the server has to have extra connection wires. Furthermore, these connection wires have to be properly organized, which will be reflected in the cost. Since floppy disk drives and CD-ROM's are not main equipment for the server they are seldom used. Thus, connecting these unnecessary peripheral devices to the server all the time increases unnecessary costs and wastes space,

Accordingly, how to use the fewest connection wires to get the most support of peripheral devices is an important challenge for people designing high-density servers.

### SUMMARY OF THE INVENTION

In the view of the foregoing, the invention provides a control system for peripheral devices of a high-density server. It utilizes a USB interface and connection wires to connect with the peripheral devices. The invention supports basic peripheral devices, and lowers the number and cost of the connection wires.

The control system for the peripheral devices of the high-density server uses a USB interface to connect with several motherboards, system connection back panels and system management units. It is also used to control several peripheral devices, including several motherboard USB ports, a USB interface switching module, a USB extension device and a switch control unit. The motherboard USB ports are used for connecting with the motherboards. The USB interface switching module is installed on the connection back panel of the system, which uses several USB connection wires to connect to the several motherboards, respectively. The USB connection wires are connected with the switches of the USB interface switching module. The switches are connected to a USB output port. The USB extension device is installed in the system management unit, which uses a USB connection wire to connect to the USB output port of the USB interface switching module as a USB signal input port. The USB extension device with several USB extending ports is connected to the peripheral devices through a USB connection wire. Finally, the switch control unit, installed in the system management unit and connected to the switching module, outputs a switching signal to the switching module to control ON and OFF of the switches, determining the connections between the motherboards and the peripheral devices.

### BRIEF DESCRIPTION OF THE DRAWINGS

FIG. 1 is a block diagram of a high-density server;

FIG. 2 is a block diagram of the disclosed control system for peripheral devices of a high-density server; and

FIG. 3 shows an explicit embodiment of the control system for peripheral devices of a high-density server.

### DETAILED DESCRIPTION OF THE INVENTION

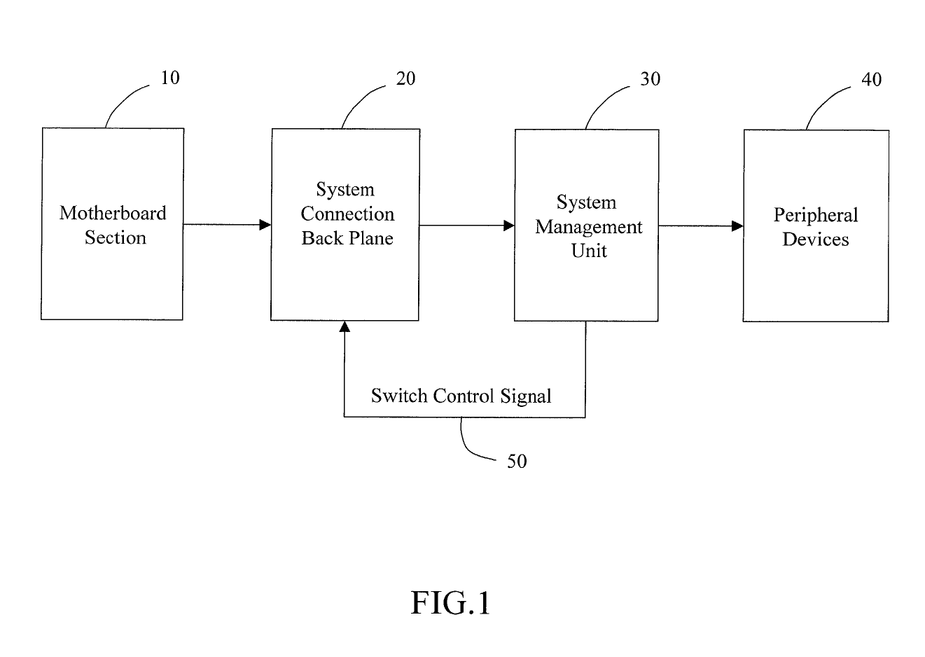

FIG. 1 depicts the relevant components of a high-density server in accordance with the present invention. It includes a motherboard sector 10, a system connection back 10 panel 20, a system management unit 30 and a peripheral device 40.

The motherboard sector 10 contains many motherboards with different functions. The motherboard sector 10 is connected to the system connection back panel 20 by a connection wire. The system connection back panel 20 is connected with the system management unit 30 by a connection wire. The system management unit 30 is connected to the peripheral device 40 by a connection wire. Referring to FIG. 1, by connecting the motherboard sector 10, the system connection back panel 20, the system management unit 30 and the peripheral device 40 together, the motherboards in the motherboard sector 10 can transmit signals for controlling the peripheral device 40 through the connection wire. In the system management unit 30, a switching control signal 50 is designed to control the connection between the system connection back panel 20, the motherboard in the motherboard sector 10 and the peripheral device 40. Different switching control signals represent different connections between the motherboards and the peripheral device 40. In other words, each switching control signal determines the control and operation of a single motherboard on the peripheral device.

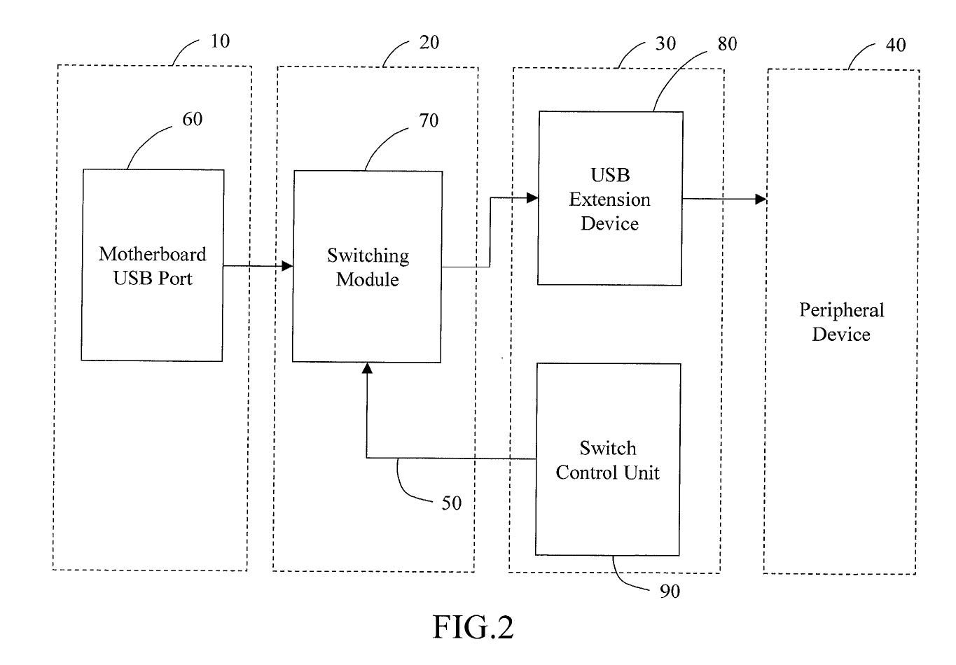

With reference to FIG. 2, the control system includes a motherboard USB port 60, a switching module 70, a USB extension device 80 and a switch control unit 90. FIG. 2 shows that the invention utilizes a USB interface to connect many of the motherboards with the system connection back panel and the system management unit, controlling the connections between the motherboard and the peripheral device 40.

There is a motherboard USB port 60 in each motherboard. The USB port 60 is connected to the peripheral device 40 through the switching module 70 and the USB extension device 80, thereby controlling the peripheral device 40. The ON and OFF of the switch is controlled by the switch control unit 90. As shown in FIG. 2, the switching module 70 is installed in the system connection back panel 20; the USB extension device 80 and the switch control unit 90 are installed in the system management unit 30.

Therefore, the switch control signal 50 is transmitted through the switch control unit 90 in the system management unit 30 to control ON and OFF of the switching module 70. The switching module turns on when the switch control unit 90 sends out an ON signal. The motherboard can then be connected with the peripheral device 40 to be controlled through the motherboard USB port 60, the switching module 70 and the USB extension device 80. The switching module turns off when the switch control unit 90 sends out an OFF signal. In the meantime, the motherboard is unable to control and operate the peripheral device 40.

Consequently, to determine whether the motherboard controls the peripheral device 40, one only needs to control the output of the switch control unit 90.

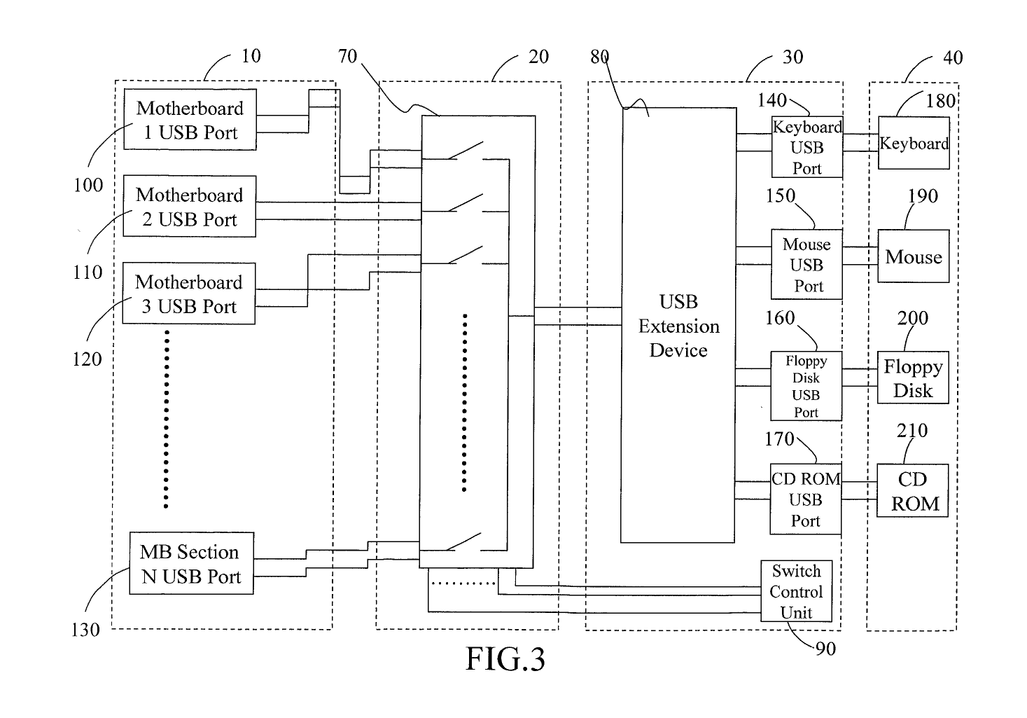

FIG. 2 illustrates the switch control mechanism over several motherboards in the invention. Please refer to FIG. 3, which illustrates the control of the multiple motherboards in an embodiment of the invention.

In FIG. 3, the motherboard sector 10 includes a motherboard 1 USB port 100, a motherboard 2 USB port 110, a motherboard 3 USB port 120, . . . and a motherboard N USB port 130. Each USB port 100˜130 (1˜N) of the motherboards is connected to the switching module 70 of the system connection back panel 20 through the USB connection wire. There are several switches in the switching module 70. Each of the switches corresponds to a USB connection wire. The other end of each switch is connected to a common USB output terminal parallel to one another. The USB output terminal is connected to the USB extension device 80. The USB extension device extends a USB interface into four USB ports, which are assigned as a keyboard USB port 140, a mouse USB port 150, a floppy disk USB port 160 and a CD-ROM USB port 170. The keyboard USB port 140, the mouse USB port 150, the floppy disk USB port 160 and the CD-ROM USB port 170 are connected respectively to a keyboard 180, a mouse 190, a floppy disk 200 and a CD-ROM 210 through USB connection wires.

In addition, the switch control unit 90 is installed in the system management unit, as shown in FIG. 3. The switch control unit 90 is connected to the switching module 70 through several signal lines. The number of signal lines is determined by the number of motherboards. That is, the number of switch signal lines is N when the number of motherboards is 2 to the Nth power. For example, when the number of motherboards is 2, the number of switch signal lines is 1. When the number of motherboards is 8, the number of switch signal lines is 3.

Therefore, the switch control unit 90 can control the switching module 70 through the signal lines. For example, the switch of the motherboard 1 USB port 100 controlled by the switch control unit 90 is ON, while other switches are all OFF at this time. In this case, only the motherboard 1 USB port 100 is connected with the switching module 70 and the USB extension device 80 through a USB connection wire to control the peripheral devices 40, such as a keyboard 180, a mouse 190, a floppy disk 200 or a CD-ROM 210.

Likewise, when the switch of the motherboard 2 USB port 110 controlled by the switch control unit 90 is ON, the other switches are OFF. In other words, only the motherboard 2 USB port 110 is connected with the switching module 70 and the USB extension device 80 through a USB connection wire to control a peripheral device 40, such as a keyboard 180, a mouse 190, a floppy disk 200 or a CD-ROM 210.

Through the control of the switch control unit 90, the invention accomplishes the function of controlling the connection between the motherboards and the peripheral devices of the server. So, an objective of the invention is to add the switch control unit 90 into the system management unit 30 and to add the switching module 70 into the system connection back panel 20 to control the connection between the motherboards and the peripheral devices 40 of the server through the control signals transmitted by the signal lines.

### EFFECTS OF THE INVENTION

The disclosed control system for peripheral devices of a high-density server can easily connect and control peripheral devices using a switching module without too many connection wires.

What is claimed is:

1. A control system for peripheral devices of a high-density server utilizing a USB interface to connect a plurality of motherboards of the high-density server, a system connection back panel and a system management unit for controlling a plurality of peripheral devices, which comprises:
a plurality of motherboard USB ports for connecting the plurality of motherboards;
a USB interface switching module, which is installed on the system connection back panel and connects to the plurality of motherboards through a plurality of USB connection wires, the plurality of USB connection wires connecting to a plurality of switches in the USB interface switching module and the plurality of switches connecting together to a USB output port;
a USB extension device, which is installed on the system management unit and uses a USB connection wire to connect with the USB output port of the USB interface switching module as a USB signal output port, the USB extension device further having a plurality of USB extension ports each of which connects to one of the plurality of peripheral devices through a USB connection wire; and
a switch control unit, which is installed on the system management unit and connects to the switching module for outputting a switching signal to the switching module to control the ON and OFF of the plurality of switches, thereby determining the connections among the plurality of motherboards and the plurality of peripheral devices.

2. The control system of claim 1, wherein the plurality of switches in the USB interface switch module receive the control signals from the switch control unit, turn on one of the plurality of switches and turn off the rest switches.

3. The control system of claim 1, wherein the number of signal lines conveying the switching signals of the switch control unit is determined by the number of the plurality of motherboards.

4. The control system of claim 3, wherein the number of the plurality of motherboards is 2 to the Nth power and the number of switch signal lines is N.

5. The control system of claim 1, wherein the plurality of USB ports of the USB extension device includes keyboard USB ports, mouse USB ports, floppy disk drive USB ports and CD-ROM USB ports.

6. The control system of claim 1, wherein the plurality of peripheral devices includes a keyboard, a mouse, a floppy disk drive and a CD-ROM.
